(19) United States
(12) Patent Application Publication
(10) Pub. No.: US 2018/0096316 A1
(43) Pub. Date: Apr. 5, 2018

(54) SYSTEMS AND METHODS FOR AN ONLINE MARKETPLACE PROVIDING DIRECT TO CONSUMER SALES

(71) Applicant: Samuel Mendez, Dallas, TX (US)

(72) Inventor: Samuel Mendez, Dallas, TX (US)

(21) Appl. No.: 15/282,663

(22) Filed: Sep. 30, 2016

(51) Int. Cl. G06Q 20/06; G06Q 20/40; G06Q 20/10

(52) U.S. Cl. CPC G06Q 20/065; G06Q 20/10; G06Q 20/401

(57) ABSTRACT

A system and method of controlling an online marketplace is disclosed. Embodiments use block chain technology to track alternative currency balances for consumers to use in a direct to consumer sales portal. An electronic vault stores alternative currency (for example, crypto-currency) balances for use in purchasing products or services through the online marketplace. Thus, the need for using banks or other currency service providers to authorize transactions is eliminated.

### CROSS-REFERENCE TO RELATED APPLICATIONS

This application claims benefit under 35 U.S.C. § 119(e) of pending Provisional Application having Ser. No. 62/235,421 filed Sep. 30, 2015, which is hereby incorporated by reference herein in its entirety.

### BACKGROUND

The embodiments herein relate generally to systems providing an online marketplace for direct to consumer sales.

Many online product and service providers and particularly direct sales or direct-to-consumer companies (also known as, multi-level marketing companies, network marketing companies or affiliate marketing companies) suffer under current commercial systems since the banks and payment processors that control and operate the online payments system place onerous and arbitrary conditions and restrictions on these companies for the ability to accept online payments. Traditional banking services, in an effort to provide security, bog down the process using archaic transaction confirmation procedures and oversight by personnel for risk assessment of transactions. As can be seen, there is a need for a system that relieves direct sales and direct-to-consumer companies from having to use traditional banking services.

### SUMMARY

In one aspect of the subject technology, a computer program product for controlling a direct sales to consumer marketplace for consumers and sellers, comprises a non-transitory computer readable storage medium having computer readable program code embodied therewith. The computer readable program code is configured to: host an online electronic portal through a network, the online electronic portal providing an online marketplace; provide a consumer side electronic interface through the online electronic portal for a consumer to engage with the online marketplace; provide a seller side electronic interface through the online electronic portal for a merchant to engage with the online marketplace; store in an electronic vault, an account associated with the consumer, the account configured to store and release funds based on cryptocurrency; provide an online sales transaction interface between the consumer and the merchant for execution of a transaction associated with a product or service being sold by the merchant; receive a purchase request from the consumer for the product or service being sold by the merchant; determine whether the consumer has sufficient cryptocurrency funds within the electronic vault for purchasing the product or service from the merchant; and execute the transaction by paying the merchant using the cryptocurrency funds in the consumer's account in response to the consumer having sufficient cryptocurrency funds within the electronic vault.

In another aspect of the subject technology, a host server comprises a storage medium and a processing unit connected to the storage medium. The storage medium store in a digital electronic vault file, an account file associated with a registered consumer. The account file may track stored and released funds based on cryptocurrency. The processing unit may manage an online electronic portal through a network connected to the host server. The online electronic portal may provide an online marketplace for the registered consumer to engage in e-commerce-based transactions. The processing unit may also provide a consumer side electronic interface through the online electronic portal for the registered consumer to engage with the online marketplace; provide a seller side electronic interface through the online electronic portal for a merchant to engage with the online marketplace; provide an online sales transaction interface between the registered consumer and the merchant for execution of a transaction associated with a product or service being sold by the merchant; receive a purchase request from the consumer for the product or service being sold by the merchant; determine, by accessing the storage medium, whether the consumer has sufficient cryptocurrency funds within the digital electronic vault for purchasing the product or service from the merchant; and execute the transaction by retrieving from the storage medium, the cryptocurrency funds in the consumer's account necessary to pay the merchant in response to the consumer having sufficient cryptocurrency funds within the electronic vault.

In still yet another aspect, a method of controlling a direct sales to consumer marketplace for consumers and sellers comprises hosting an online electronic portal through a network, the online electronic portal providing an online marketplace; providing a consumer side electronic interface through the online electronic portal for a consumer to engage with the online marketplace; providing a seller side electronic interface through the online electronic portal for a merchant to engage with the online marketplace; storing in an electronic vault, an account associated with the consumer, the account configured to store and release funds based on cryptocurrency; providing an online sales transaction interface between the consumer and the merchant for execution of a transaction associated with a product or service being sold by the merchant; receiving a purchase request from the consumer for the product or service being sold by the merchant; determining whether the consumer has sufficient cryptocurrency funds within the electronic vault for purchasing the product or service from the merchant; and executing the transaction by paying the merchant using the cryptocurrency funds in the consumer's account in response to the consumer having sufficient cryptocurrency funds within the electronic vault.

### BRIEF DESCRIPTION OF THE FIGURES

The detailed description of some embodiments of the invention is made below with reference to the accompanying figures, wherein like numerals represent corresponding parts of the figures.

FIG. 1 is a flow diagram of a method of transacting direct to consumer sales within an online marketplace according to an embodiment of the subject technology.

FIG. 2 is a block diagram of a computer system/server according to an embodiment of the subject technology.

FIG. 3 is a block diagram of a network according to an embodiment of the subject technology.

### DETAILED DESCRIPTION OF CERTAIN EMBODIMENTS

In general embodiments of the disclosed invention provide system, method, and software embodiments for controlling an online marketplace providing direct to consumer sales transactions. As will be appreciated, embodiments disclosed herein improve upon the fields related to network systems, network security and compatibility between parties involved electronic transactions within network systems. Aspects of the subject technology solve problems related to electronic transactions and in particular to e-commerce transactions. As discussed above, direct sellers and their affiliates suffer from drawbacks in the current approaches to receiving payment electronically. Prior to an electronic transaction being executed, many levels of risk assessment may be performed before the transaction is consummated. To consummate the transaction, more than one party may be referenced to evaluate whether funds are available are authorized for use. Thus, an online merchant may need to rely on a system that contacts one other processing service which in turn contacts one or more other sources to authorize or deny funding for a transaction under conventional electronic systems.

Some merchant sites are not compatible with many electronic payment systems. Known systems such as credit card processing require agreements with various credit card processers (and sometimes the issuing banks) which raises the cost of the product or service through the use of transaction fees. Online merchant sites may sometimes have to contract with a separate module service that uses an API to interface with the merchant site to handle electronic payment. Thus consumers trying to purchase through the auxiliary service handling payment must meet the credit card requirements of the auxiliary service. Sometimes, impulse buyers, consumers filled with buyers regret, or scammers request a chargeback for products or services which adds further risk and loss to the merchant side. Third party processors and banks may be more sympathetic to the consumer and are apt to hold payment even though services have been rendered because then the funds remain in the bank's possession and usable for leveraging.

For those consumers that do not have an accepted form of payment back by an issuing bank, the online sites cannot accommodate a sales transaction and thus merchants suffer lost sales as a result. Moreover, the individual online merchants may need to contract with various processing services to sell their products or services to capture the various consumers that use different forms of electronic payment/credit. This adds another layer to an e-commerce transaction that can be compromised by hackers/malware or produce errors in the transaction. To further complicate matters, purchases from consumers and merchants across jurisdictions may invoke currency conversion procedures or procedures to confirm proof of funds from a foreign bank which delay purchase execution.

Embodiments of the subject technology provide a system with compatibility between direct sellers of products or services and consumers within e-commerce systems. A host server provides a direct interface with an online merchant and provides proof of funds for a consumer so a product or service can be confirmed purchased from a merchant without the need of interfacing with third party banks, credit processors, transaction service providers, or currency conversions. In exemplary embodiments, blockchain technology is implemented within an online marketplace so that transactions between consumers and merchants are performed securely without the need for risk assessment. The subject technology allows direct sales companies to bypass the traditional banking system to accept online payments for their products or services by utilizing a marketplace where payments in and payments out are conducted with alternative currency or cryptocurrency (for example, Bitcoin). Companies may sell their products and services to consumers and receive alternative currencies or cryptocurrencies as payment. Moreover, aspects of the system allow direct sales and direct-to-consumer companies to pay out financial rewards (commissions, royalties, bonuses, etc.) to their independent contractor/distributors using alternative currency without using the traditional banking system and its requirements, restrictions and potential impediments.

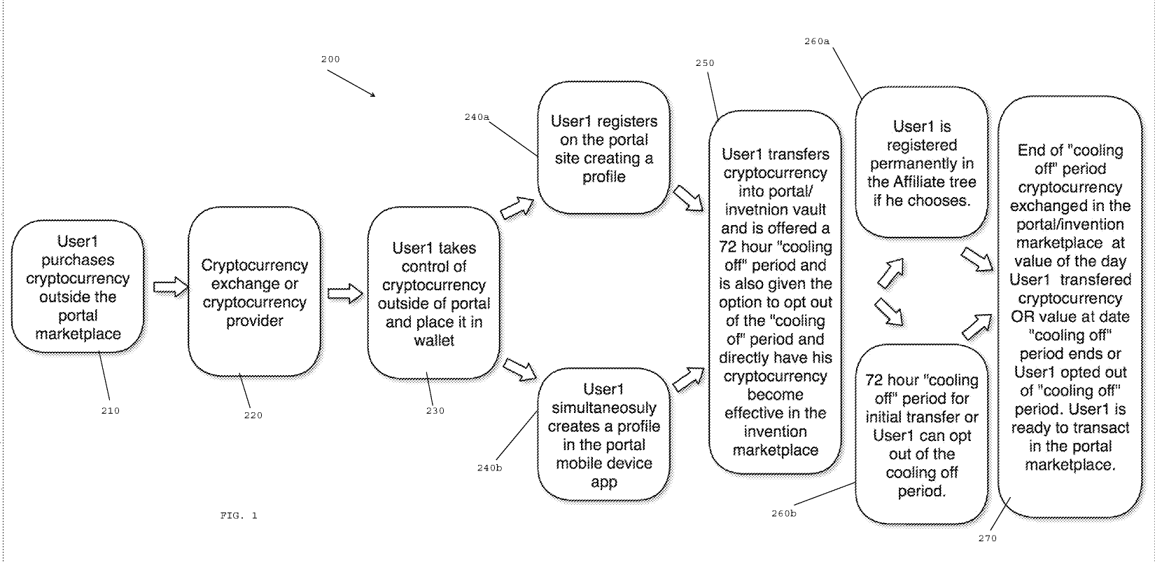

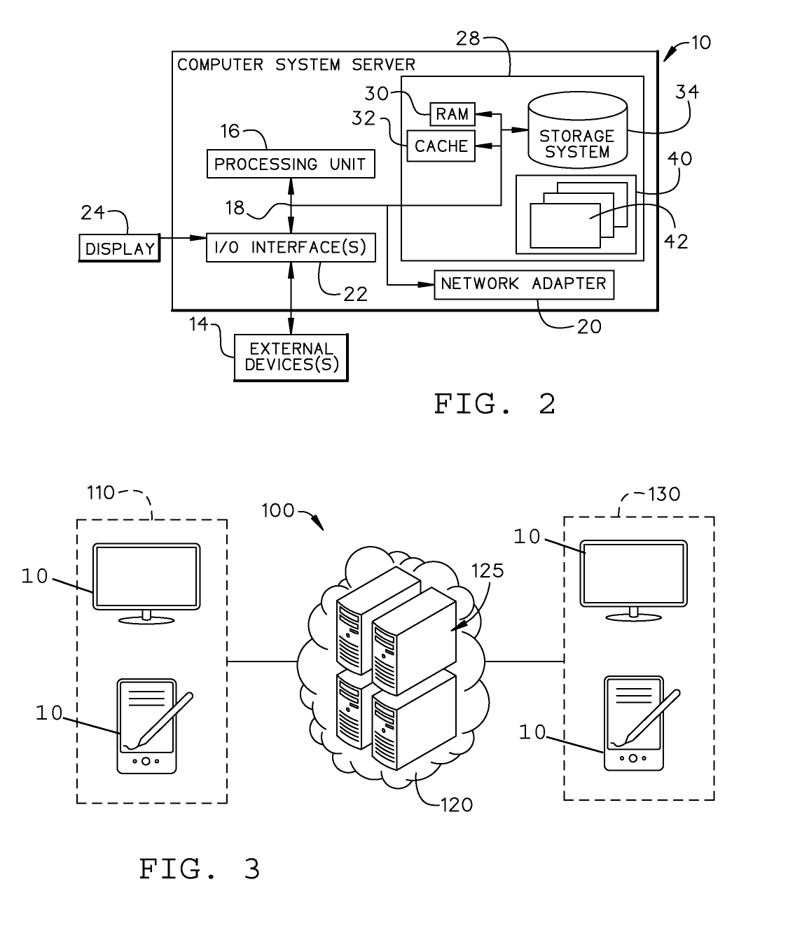

Referring now to FIGS. 1-3 concurrently, a method 200 (FIG. 1) of providing direct to consumer sales using for example, a system 100 (FIG. 3) as described below is shown according to an exemplary embodiment of the subject technology. As will be understood, embodiments are performed within an electronic online environment. Many of the functions will be performed by a general computing machine 10 and/or specific elements of the general computing machine 10. In an exemplary embodiment, transactions between direct sellers and consumers will be through the use of alternative currencies within a block chain environment, for example crypto-currency. As will be appreciated, the use of crypto-currency relieves the need to engage banks for risk assessment of commercial transactions. Referring now to FIG. 2, a schematic of an example of a general computing machine 10 is shown. The general computing machine 10 is shown in the form of a general-purpose computing device; however some elements may be configured/programmed to provide a special purpose machine for the system 100. The details of the general computing machine 10 will be described further below with respect to FIG. 2.

The system 100 generally includes a consumer side 110, a seller side 130 (an online merchant which may be for example, a direct seller/direct sales entity), and a network 120. The network 120 may include a server(s) 125 storing a software embodiment of the disclosed invention and acting as an intermediary providing the online marketplace and the blockchain environment for the marketplace. The consumer side 110 and seller side 130 may interact with the system 100 through respective general computing machines 10. The server 125 likewise may function for example, under the description of the general computing machine 10. From the consumer side, the general computing machine 10 may serve the role as the machine implementing for example the functions of providing a user interface for transacting cryptocurrency purchases/exchanges with third parties (which may be outside of the system 100), engaging with the online marketplace in network 100 and in consumer transactions in general. In some embodiments, this may be through a mobile device app usable on mobile electronic device (described in more detail below). From the seller side 130, the general computing machine 10 may serve the role as the machine implementing for example the functions of providing a user interface for transacting cryptocurrency purchases/exchanges (which may occur outside of the system 100), selling products within the online marketplace in network 100, and rewarding third parties. The server(s) 125 may serve as the machine(s) hosting the online marketplace for direct to consumer sales, wherein consumer side 110 purchases or products/services from the seller side 130 may be transacted and the exchange of alternative currency (for example, cryptocurrency) is transacted. An exemplary method 200 will now be described with reference to numbered blocks in parentheses describing actions with continuing reference to the machines and systems of FIGS. 2-3.

A user (consumer) purchases (210) alternative currency (for example, crypto-currency). The currency purchase may be performed (220) outside of the system 100 and the marketplace from a currency exchange or provider. The user takes control (230) of the currency. In some embodiments, the currency may be stored in a digital wallet associated with the user. In blocks (240a) and (240b), the user registers their account/profile through an electronic portal interface connected to the system 100. In some embodiments, this may be performed through the aforementioned mobile device app. In some embodiments, the system 100 may include digital storage holding the user's account information and an electronic vault storing user currency balances. The electronic vault may be stored for example on one or more of the servers 125. In block 250, the user's purchased currency funds may be transferred and stored into the electronic vault. Some embodiments may include a cooling off period that does not allow use of the newly transferred in currency for a pre-determined time (for example, 72 hours). As may be appreciated, this may benefit consumers that are prone to impulse purchases which may result in a request for refund, which is a negative event for merchants. Some embodiments may have no cooling off period or allow the user to waive off the cooling off period for immediate use in the marketplace. During the cooling off period, the user may permanently register (block 260a) with an affiliate tree. An affiliate tree may comprise members of a direct sales force (for example, distributors, independent contractors, etc.) that contribute to the generation of sales. Being part of an affiliate tree may expose the user to a rewards system. For example, affiliates may offer rewards for sales activity related to the user. The rewards may be directly correlated with the currency used. As may be appreciated, the use of an alternative currency provides an added benefit to the seller side by directly correlating sales with the currency value without adjustments related to transaction fees or conversion fees. Otherwise, if the cooling off period expired or the user chose to waive off the cooling off period (block 260b), then direct to consumer sales may be performed (270) in the online marketplace.

The user (consumer side 110) may for example, engage directly with a direct sales entity 130 and its electronic site to purchase a product or service. The direct sales entity 130 may make a request to the server(s) 125 to confirm whether sufficient funds are available in the consumer's account. The sales entity's site may include a software module directly compatible with the server(s) 125. The module may generate an encrypted packet which may include the request, an amount of crypto-currency requested, and the identification of the consumer. The product or service may not necessarily be included in the request. The server(s) 125 may include a module for communicating with the merchant site's module for receiving the encrypted packet. Once the packet is received by the server(s) 125, the server(s) 125 may reference the consumer's account and determine if sufficient funds are present for the purchase price amount in crypto-currency. If the consumer's account has sufficient funds, the transaction is executed and the crypto-currency amount is transferred to an account associated with the online merchant. The online merchant account may also be stored in the system 100 server(s) 125. A message is sent to the online merchant authorizing purchase. As may be appreciated, blockchain technology which may use a public ledger may be used to ensure that the funds associated with the user (consumer side 110) are not manipulated and duplicate transactions with a single amount of currency are not transacted across multiple online merchants. Multiple servers 125 may ensure that the consumer side 110 has sufficient funds for each purchase before executing any transaction. In addition, since the consumer's account information may be located within the same system 100 as the online merchant's account, the need to reference a third party outside of the system is avoided and the potential for intercepting the funds transfer is mitigated.

Referring back now to FIG. 2, the details of the general computing machine 10 are described. The components of the general computing machine 10 may include, but are not limited to, one or more processors or processing units 16, a system memory 28, and a bus 18 that couples various system components including the system memory 28 to the processor 16. In some embodiments, the processor 16 may be a special purpose processor 16 for performing blockchain transactions described above. The general computing machine 10 may be for example, personal computer systems, tablet devices, mobile telephone devices, wearable computing devices, handheld or laptop devices, multiprocessor systems, microprocessor-based systems, set top boxes, or programmable consumer electronics when serving as the terminal for the consumer side 110 or seller side 130 machines. The general computing machine 10 may be for example server computer systems, network PCs, and distributed cloud computing environments that include any of the above systems or devices, and the like when serving as the network server(s) 125 or host for the online marketplace. The general computing machine 10 may be described in the general context of computer system executable instructions, such as program modules, being executed by a computer system. In some embodiments, the general computing machine 10 may be a cloud computing node connected to a cloud computing network. The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The general computing machine 10 may typically include a variety of computer system readable media. Such media could be chosen from any available media that is accessible by the general computing machine 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention described for example by the method 200 and Figures in general above.

The computer system/server 10 may also communicate with one or more external devices 14 such as a keyboard, a pointing device, a display 24 (which provides a user interface and displays for example the online electronic portal interface to either the consumer side 110 and/or the seller side 130), etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for controlling a direct sales to consumer marketplace for consumers and sellers, the computer program product comprising a non-transitory computer readable storage medium having computer readable program code embodied therewith, the computer readable program code being configured, when executed by a processor, to:
host an online electronic portal through a network, the online electronic portal providing an online marketplace;
provide a consumer side electronic interface through the online electronic portal for a consumer to engage with the online marketplace;
provide a seller side electronic interface through the online electronic portal for a merchant to engage with the online marketplace;
store in an electronic vault, an account associated with the consumer, the account configured to store and release funds based on cryptocurrency;
provide an online sales transaction interface between the consumer and the merchant for execution of a transaction associated with a product or service being sold by the merchant;
receive a purchase request from the consumer for the product or service being sold by the merchant;
determine whether the consumer has sufficient cryptocurrency funds within the electronic vault for purchasing the product or service from the merchant; and
execute the transaction by paying the merchant using the cryptocurrency funds in the consumer's account in response to the consumer having sufficient cryptocurrency funds within the electronic vault.

2. The computer program product of claim 1, further comprising computer readable code configured to confirm through a blockchain ledger whether the cryptocurrency funds in the consumer's account have been used for another transaction.

3. The computer program product of claim 1, further comprising computer readable code configured to provide a cooling off period preventing the consumer from using cryptocurrency funds for a predetermined time after receiving cryptocurrency funds deposited into the consumer's account.

4. The computer program product of claim 1, wherein the seller side electronic interface is configured to interface directly with a direct seller's system offering the product or service.

5. A host server, comprising:
a storage medium configured to store in a digital electronic vault file, an account file associated with a registered consumer, the account file configured to track stored and released funds based on cryptocurrency; and
a processing unit connected to the storage medium, the processing unit configured to:
manage an online electronic portal through a network connected to the host server, the online electronic portal providing an online marketplace for the registered consumer to engage in e-commerce-based transactions;
provide a consumer side electronic interface through the online electronic portal for the registered consumer to engage with the online marketplace;
provide a seller side electronic interface through the online electronic portal for a merchant to engage with the online marketplace;
provide an online sales transaction interface between the registered consumer and the merchant for execution of a transaction associated with a product or service being sold by the merchant;
receive a purchase request from the consumer for the product or service being sold by the merchant;
determine, by accessing the storage medium, whether the consumer has sufficient cryptocurrency funds within the digital electronic vault for purchasing the product or service from the merchant; and
execute the transaction by retrieving from the storage medium, the cryptocurrency funds in the consumer's account necessary to pay the merchant in response to the consumer having sufficient cryptocurrency funds within the electronic vault.

6. The host server of claim 5, wherein the processing unit is configured to confirm through a blockchain ledger whether the cryptocurrency funds in the consumer's account have been used for another transaction and deny or execute the transaction based on whether the cryptocurrency funds were used in the another transaction.

7. The host server of claim 5, wherein the processing unit is configured to provide a cooling off period preventing the consumer from using cryptocurrency funds for a predetermined time after receiving cryptocurrency funds deposited into the consumer's account.

8. The host server of claim 5, wherein the seller side electronic interface is configured to interface directly with a direct seller's system offering the product or service.

9. A method of controlling a direct sales to consumer marketplace for consumers and sellers, comprising:
hosting an online electronic portal through a network, the online electronic portal providing an online marketplace;
providing a consumer side electronic interface through the online electronic portal for a consumer to engage with the online marketplace;
providing a seller side electronic interface through the online electronic portal for a merchant to engage with the online marketplace;
storing in an electronic vault, an account associated with the consumer, the account configured to store and release funds based on cryptocurrency;
providing an online sales transaction interface between the consumer and the merchant for execution of a transaction associated with a product or service being sold by the merchant;
receiving a purchase request from the consumer for the product or service being sold by the merchant;
determining whether the consumer has sufficient cryptocurrency funds within the electronic vault for purchasing the product or service from the merchant; and
executing the transaction by paying the merchant using the cryptocurrency funds in the consumer's account in response to the consumer having sufficient cryptocurrency funds within the electronic vault.

10. The method of claim 9, further comprising confirming through a blockchain ledger whether the cryptocurrency funds in the consumer's account have been used for another transaction.

11. The method of claim 9, further comprising providing a cooling off period preventing the consumer from using cryptocurrency funds for a predetermined time after receiving cryptocurrency funds deposited into the consumer's account.

12. The method of claim 9, further comprising, interfacing the seller side electronic interface directly with a direct seller's system offering the product or service.
